(19) United States
(12) Patent Application Publication
(10) Pub. No.: US 2020/0226606 A1
(43) Pub. Date: Jul. 16, 2020

(54) METHOD AND SYSTEM FOR MAXIMIZING RISK-DETECTION COVERAGE WITH CONSTRAINT

(71) Applicant: Alipay Labs (Singapore) Pte. Ltd., Singapore (SG)

(72) Inventors: Jian DU, San Mateo, CA (US); Zhigang HUA, San Mateo, CA (US); Shuang YANG, San Mateo, CA (US)

(21) Appl. No.: 16/831,668

(22) Filed: Mar. 26, 2020

(51) Int. Cl. G06Q 20/40; G06F 16/903

(52) U.S. Cl. CPC G06Q 20/4016; G06F 16/90335; G06Q 20/405

(57) ABSTRACT

Methods, systems, and apparatus, including computer programs encoded on computer storage media, for risk detection. One exemplary method may comprise: obtaining a first subset of a plurality of risk-detection rules, the first subset being associated with a first coverage score; constructing, based on the first subset, a lower-bound data mapping that outputs an approximate coverage score for an input subset; and constructing, based on the first subset, an upper-bound data mapping comprising a set of parameters; and generating a third subset of the plurality of risk-detection rules; and in response to the first coverage score exceeding the third coverage score, selecting rules in the first subset for risk-detection on a new transaction.

### TECHNICAL FIELD

The disclosure relates generally to systems and methods for maximizing risk-detection coverage with constraint.

### BACKGROUND

Fraud prevention and risk detection are perennial apprehensions for online service providers, such as online banking, online payment systems, etc. These tasks are usually handled by risk management systems that replay on rules. Each rule may include multiple conditions to evaluate a transaction. A transaction may be correctly or falsely identified as risky (or safe) by a rule. The correct identifications may improve the risk-detection coverage (e.g., capability of detecting various risky transactions), but the false identifications may result in higher customer disruption rate (e.g., customer dissatisfaction caused by a benign transaction being denied as malicious). Among these rules, some may be created based on empirical experiences, while some may be provided by machine learning models like decision trees. It is often that some of the rules are overly-aggressive where they not only cover fraudulent and risky transactions, but also interrupt benign transactions (e.g., false positive identifications causing customer disruption). Therefore, it is desirable to design an efficient way to select rules to cover as many fraudulent/risky transactions as possible and in the meantime keep the number of interrupted transactions below a predefined value.

### SUMMARY

Various embodiments of the present specification may include systems, methods, and non-transitory computer readable media for risk detection.

According to one aspect, the method for risk detection may comprise: obtaining a first subset of a plurality of risk-detection rules, the first subset being associated with a first coverage score and a first disruption score, wherein: the first coverage score indicates a number of unique historical transactions that have been correctly identified by the plurality of risk-detection rules in the first subset, and the first disruption score indicates a number of unique historical transactions that have been falsely identified by the plurality of risk-detection rules in the first subset; approximate coverage score for an input subset, wherein: when the input subset is the first subset, the approximate coverage score is the same as the first coverage score, and when the input subset is a second subset different from the first subset, the approximate coverage score is not greater than a second coverage score associated with the second subset, the second coverage score indicating a number of unique historical transactions that have been correctly identified by risk-detection rules in the second subset; and constructing, based on the first subset, an upper-bound data mapping comprising a set of parameters, wherein: the upper-bound data mapping outputs an approximate disruption score for the input subset of the plurality of risk-detection rules, when the input subset is the first subset, the output approximate disruption score is the same as the first disruption score, and when the input subset is the second subset different from the first subset, the output approximate disruption score is not less than a second disruption score associated with the second subset, the second disruption score indicating a number of unique historical transactions that have been falsely identified as risky transactions by risk-detection rules in the second subset; and according to the first subset, the lower-bound data mapping, and the upper-bound data mapping, generating a third subset of the plurality of risk-detection rules based at least on: the approximate coverage scores output by the lower-bound data mapping corresponding to the plurality of risk-detection rules as inputs, and the set of parameters associated with the upper-bound data mapping, wherein the third subset is associated with a third coverage score indicating a number of unique historical transactions that have been correctly identified by the plurality of risk-detection rules in the third subset; comparing the first coverage score with the third coverage score; and in response to the first coverage score exceeding the third coverage score, selecting rules in the first subset for risk-detection on a new transaction.

In some embodiments, the method further comprises: in response to the first coverage score not exceeding the third coverage score, replacing the first subset with the third subset as an updated first subset, wherein the first coverage score is correspondingly replaced with the third coverage score of the third subset; cyclically performing one or more iterations of a process based on the constructing step and the generating step until an exit condition is met, the process comprising: updating, based on the updated first subset, the lower-bound data mapping; generating, based on the updated first subset and the updated lower-bound data mapping, an updated third subset associated with an updated third coverage score; and if the exit condition is not met, replacing the updated first subset with the updated third subset, and the updated first coverage score with the updated third coverage score.

In some embodiments, the exit condition comprises at least one of following: the updated first coverage score being greater than the updated third coverage score, and a number of the one or more iterations being greater than a preset number.

In some embodiments, the lower-bound data mapping comprises a submodular and monotonic function.

In some embodiments, the first subset is empty.

In some embodiments, the constructing a lower-bound data mapping comprises: generating a sequence by reordering the plurality of risk-detection rules, wherein risk-detection rules in the first subset are placed first in the sequence; based on the generated sequence, constructing a list of temporal subsets Sᵢ, 0≤i≤n, wherein: n is a quantity of the plurality of risk-detection rules, temporal subset S₀ is empty, and for a given i where 1≤i≤n, temporal subset Sᵢ comprises an iₜₕ risk-detection rule in the sequence and all risk-detection rules in temporal subset Sᵢ₋₁; determining the approximate coverage score for each risk-detection rule in the generated sequence; and determining a coverage score for a given subset of the plurality of risk-detection rules as a sum of the approximate individual coverage score of each risk-detection rule in the given subset.

In some embodiments, the determining the approximate individual coverage score for each risk-detection rule in the sequence comprises: for the iₜₕ risk-detection rule in the sequence, determining an approximate individual coverage score based on a difference between a coverage score of the temporal subset Sᵢ and a coverage score of the temporal subset Sᵢ₋₁, wherein the coverage score of the temporal subset Sᵢ and the coverage score of the temporal subset Sᵢ₋₁ are learned by querying the database of historical transactions.

In some embodiments, the constructing an upper-bound data mapping with a set of parameters comprises determining the set of parameters by: for each of the plurality of risk-detection rules: determining a first approximate coverage score based on the lower-bound data mapping; determining a first disruption score increase associated with adding the each risk-detection rule to a first group of risk-detection rules based on a number of unique historical transactions that have been falsely identified by the each risk-detection rule; and determining a first ratio for the each risk-detection rule, wherein the approximate coverage score is a numerator and the first disruption score increase is a denominator; generating a sequence by sorting the plurality of risk-detection rules in a descending order according to the determined first ratios of the plurality of risk-detection rules; selecting a maximum number of risk-detection rules with a first overall disruption score increases being not greater than the preset threshold, wherein the first overall disruption score is a summation of the first disruption score increases associated with the selected risk-detection rules; and determining the set of parameters as an intersection of the first subset and the selected risk-detection rules.

In some embodiments, the first group is determined as the first subset if the each risk-detection rule is not in the first subset, or as the first subset excluding the each risk-detection rule if the each risk-detection rule is in the first subset.

In some embodiments, the generating a third subset of the plurality of risk-detection rules comprises: sorting the plurality of risk-detection rules based on the first subset, the set of parameters, and the approximate coverage scores generated by the lower-bound data mapping for the plurality of risk-detection rules; and from a beginning of the sorted plurality of risk-detection rules, selecting one or more consecutive risk-detection rules as the third subset.

In some embodiments, the sorting the plurality of risk-detection rules comprises: for each of the plurality of risk-detection rules: determining a second approximate coverage score based on the lower-bound data mapping; determining a second group of risk-detection rules as the set of parameters if the each risk-detection rule is not in the first subset, or as the first subset excluding the each risk-detection rule if the each-detection rule is in the first subset; determining a second disruption score increase associated with adding the each risk-detection rule to the second group of risk-detection rules; and determining a second ratio for the each risk-detection rule, wherein the second approximate coverage score is a numerator and the second disruption score increase is a denominator; generating a sequence by sorting the plurality of risk-detection rules in a descending order according to the second ratio of the each risk-detection rule; and wherein the selecting one or more consecutive risk-detection rules as the third subset comprises: selecting a maximum number of risk-detection rules with a second overall disruption score increases being not greater than the preset threshold, wherein the second overall disruption score is a sum of the second disruption score increases associated with the selected risk-detection rules.

According to another aspect, a system for risk detection may comprise one or more processors and one or more non-transitory computer-readable memories coupled to the one or more processors and configured with instructions executable by the one or more processors to cause the system to perform operations comprising: obtaining a first subset of a plurality of risk-detection rules, the first subset being associated with a first coverage score and a first disruption score, wherein: the first coverage score indicates a number of unique historical transactions that have been correctly identified by the plurality of risk-detection rules in the first subset, and the first disruption score indicates a number of unique historical transactions that have been falsely identified by the plurality of risk-detection rules in the first subset; approximate coverage score for an input subset, wherein: when the input subset is the first subset, the approximate coverage score is the same as the first coverage score, and when the input subset is a second subset different from the first subset, the approximate coverage score is not greater than a second coverage score associated with the second subset, the second coverage score indicating a number of unique historical transactions that have been correctly identified by risk-detection rules in the second subset; and constructing, based on the first subset, an upper-bound data mapping comprising a set of parameters, wherein: the upper-bound data mapping outputs an approximate disruption score for the input subset of the plurality of risk-detection rules, when the input subset is the first subset, the output approximate disruption score is the same as the first disruption score, and when the input subset is the second subset different from the first subset, the output approximate disruption score is not less than a second disruption score associated with the second subset, the second disruption score indicating a number of unique historical transactions that have been falsely identified as risky transactions by risk-detection rules in the second subset; and according to the first subset, the lower-bound data mapping, and the upper-bound data mapping, generating a third subset of the plurality of risk-detection rules based at least on: the approximate coverage scores output by the lower-bound data mapping corresponding to the plurality of risk-detection rules as inputs, and the set of parameters associated with the upper-bound data mapping, wherein the third subset is associated with a third coverage score indicating a number of unique historical transactions that have been correctly identified by the plurality of risk-detection rules in the third subset; comparing the first coverage score with the third coverage score; and in response to the first coverage score exceeding the third coverage score, selecting rules in the first subset for risk-detection on a new transaction.

According to yet another aspect, a method for selecting a subset from a collection of candidates may comprise: obtaining a first subset of a plurality of candidates, the first subset being associated with a first true-positive score and a first false-positive score, wherein: the first true-positive score indicates a gain associated with candidates in the first subset, and the first false-positive score indicates a cost associated with candidates in the first subset; constructing, based on the first subset, a lower-bound data mapping that outputs an approximate true-positive score for an input subset, wherein: when the input subset is the first subset, the approximate true-positive score is the same as the first true-positive score, and when the input subset is a second subset different from the first subset, the approximate true-positive score is not greater than a second true-positive score associated with the second subset, the second true-positive score indicating a gain associated with candidates in the second subset; and constructing, based on the first subset, an upper-bound data mapping comprising a set of parameters, wherein: the upper-bound data mapping outputs an approximate false-positive score for the input subset of the plurality of candidates, when the input subset is the first subset, the output approximate false-positive score is the same as the first false-positive score, and when the input subset is the second subset different from the first subset, the output approximate false-positive score is not less than a second false-positive score associated with the second subset, the second false-positive score indicating a gain associated with candidates in the second subset; and according to the first subset, the lower-bound data mapping, and the upper-bound data mapping, generating a third subset of the plurality of candidates based at least on: the approximate true-positive scores output by the lower-bound data mapping corresponding to the plurality of candidates as inputs, and the set of parameters associated with the upper-bound data mapping, wherein the third subset is associated with a third true-positive score indicating a gain associated with the plurality of candidates in the third subset; comparing the first true-positive score with the third true-positive score; and in response to the first true-positive score exceeding the third true-positive score, selecting candidates in the first subset for on a new transaction.

Embodiments disclosed in the specification have one or more technical effects. In some embodiments, the problem of maximizing risk-detection coverage with constraint is formulated as a generalized submodular optimization and solved by an iterative process. In this way, the embodiments disclosed in this specification allow the constraints to be more flexible and to be given (e.g., definite values) either analytically or in terms of value oracle models, rather than a simple classical cardinality constraint in existing solutions. For example, existing solutions may only allow a risk management system to specify a number of rules that can be selected, while the embodiments disclosed in this specification may allow the risk management system to specify a variety of constraints, such as a maximum customer disruption rate, which is more practical and meaningful. In some embodiments, variational modular approximations to the involved submodular functions (e.g., both the risk-detection coverage and customer disruption rate) are constructed so that the optimal solution for maximizing risk-detection coverage may be iteratively explored. In comparison to traditional sequential searching and random searching, the iterative approach disclosed in this specification guarantees that an optimal group of risk-detection rules may be determined with a faster speed. In some embodiments, the submodularity of the risk-detection coverage and customer disruption rate are fully explored to simplify the solution searching process. For example, an upper-bound approximation of the customer disruption rate (e.g., in a form of cost function) and a lower-bound approximation of the risk-detection coverage (e.g., in a form of objective function) are constructed by taking into account the submodularity of the risk-detection coverage and customer disruption rate. These approximations are adopted to build an iterative approach where a better solution is guaranteed to be obtained at each iteration.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 illustrates a system 100 for maximizing risk-detection coverage in accordance with some embodiments.

FIG. 2A illustrates an exemplary setup for maximizing risk-detection coverage in accordance with some embodiments.

FIG. 2B illustrates an exemplary data querying system for maximizing risk-detection coverage in accordance with some embodiments.

FIG. 3 illustrates an exemplary method for maximizing risk-detection coverage in accordance with some embodiments.

FIG. 4 illustrates an exemplary diagram for maximizing risk-detection coverage in accordance with some embodiments.

FIG. 5 illustrates an example method for risk detection, in accordance with various embodiments.

FIG. 6 illustrates a block diagram of a computer system for risk detection in accordance with some embodiments.

FIG. 7 illustrates an example computing device in which any of the embodiments described herein may be implemented.

### DETAILED DESCRIPTION

Submodularity is an important property that naturally exists in many real-word scenarios. As a concrete example, diminishing returns (or decreasing marginal value) in economics refers to a phenomenon that the marginal benefit of any given element tends to decrease as more elements are added. This concept also applies to risk management systems where the marginal benefit of adding a risk-detection rule tends to decrease as more risk-detection rules have been added. Here, the marginal benefit of adding a risk-detection rule may refer to the risk-detection coverage increase (as a newly added rule may discover some new risks that the existing rules ignored). Similarly, the marginal “cost” of adding a risk-detection rule (e.g., customer dissatisfaction associated with additional customer disruption introduced by the newly added risk-detection rule) also follows the same pattern: decreasing as more risk-detection rules have been added.

In an online system involving risk-detection (e.g., online payment system, online banking system), numerous rules may be prepared to detect risky transactions. For example, such rules may include “if the location of the transaction is not the user's usual locations,” “if the transaction amount is greater than an amount and the user's credit level is below a threshold,” “if the user has typed wrong passwords for multiple times,” and so on. These rules may be deployed to determine whether to approve a credit card application, or whether a spending transaction is fraudulent, whether a login is malicious. A common task for a risk management system is to determine which (or which subset) of the rules to be invoked in order to maximize risk-detection coverage while keeping the side-effect (e.g., customer disruption) below a preset threshold.

For simplicity of explanation, let [n]={1,2, . . . ,n} be a finite ground set (e.g., a plurality of risk-detection rules) and the set of all subsets of [n] be 2^{[n]}. Each of the subsets may provide a risk-detection coverage (e.g., benefit) as well as a customer disruption rate (e.g., cost), which may be quantified based on a number of historical transactions correctly and falsely identified as risky (or safe), respectively. This specification does not limit the means of quantifying the coverage and cost. By denoting the risk-detection coverage as a function g(X), where X refers to a given subset of the risk-detection rules, and the customer disruption rate as a function of f (X), the task to maximize risk-detection coverage with constraint may be formulated a submodular maximum coverage problem as:

$${max}_{X} g ( X ) , s . t . f ( X ) \leq b \qquad ( 1 )$$

Where “s.t.” stands for “subject to,” and b refers to a preset threshold limiting the customer disruption. Both g(X) and f(X) may be submodular and monotonic (e.g., the value of the function does not decrease as X increases). The submodularity of function g(X) may be represented as g(j|X)≥g(j|Y), X⊆Y⊆[n], j not in Y, which may be interpreted as: for two given subsets X and Y, X comprising less rules than Y, the marginal gain (e.g., risk-detection coverage improvement) by adding a single rule j to X is greater than or equal to adding j to Y. The above description also applies to f(X). The monotonicity of g(X) and f(X) means the values of the functions won't decrease as X is expanded (e.g., by adding a new rule, the risk-detection coverage and the customer disruption rate won't decrease).

In some embodiments, for a given subset of the risk-detection rules, the corresponding risk-detection coverage (e.g., the value of g(x)) may be determined by querying historical information. For example, the coverage may be learned based on the quantity of historical transactions that have been correctly identified as risky (or safe) by the rules in the given subset. Similarly, the customer disruption corresponding to the given subset may be learned based on the quantity of historical transactions that have been falsely identified as risky (or safe) by the rules in the given subset. Whether a historical transaction has been correctly or falsely identified as risky (or safe) may be determined based on a comparison of the rule-based identification prior to the transaction occurrence and the manual or machine labeling of such transaction after the transaction is carried out. In some other embodiments, the risk-detection coverage and customer disruption rate may be learned by other means, such as a black box server or service (e.g., an oracle responding to queries). The specification does not limit the means to obtain the values of g(X) and f(X) for a given subset of rules X.

The embodiments described in this specification provide an iterative way to explore the optimal subset of risk-detection rules to maximize risk-detection coverage subject to a customer disruption rate constraint.

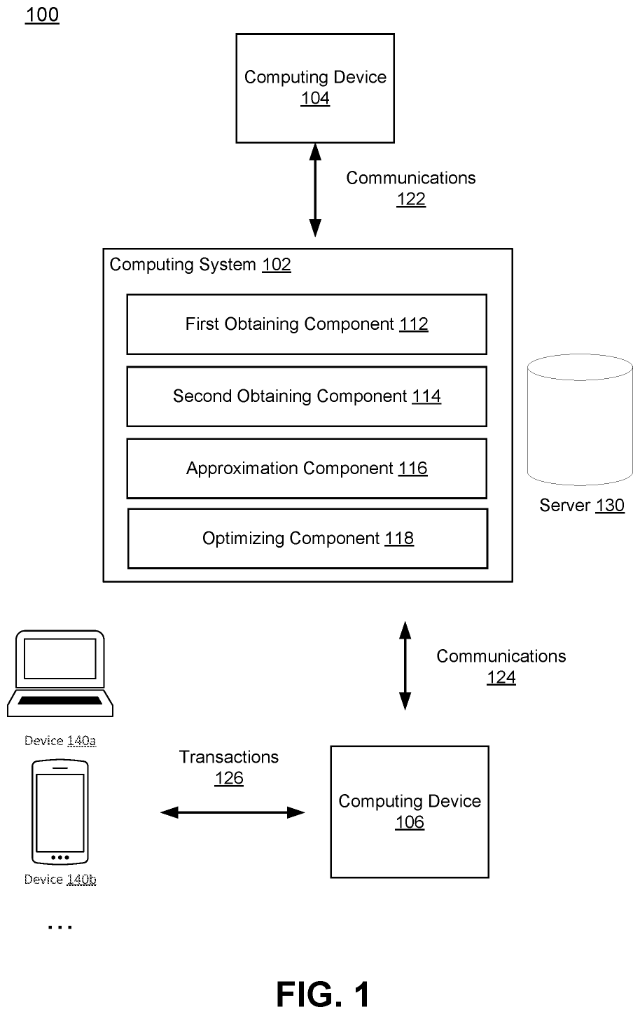

FIG. 1 illustrates a system 100 for maximizing risk-detection coverage in accordance with some embodiments. The components of the system 100 presented below are intended to be illustrative. Depending on the implementation, the system 100 may include additional, fewer, or alternative components.

In some embodiments, the system 100 may include a computing system 102, a computing device 104, and a computing device 106. It is to be understood that although two computing devices are shown in FIG. 1, any number of computing devices may be included in the system 100. The computing system 102 may be implemented in one or more networks (e.g., enterprise networks), one or more endpoints, one or more servers (e.g., server 130), or one or more clouds. The server 130 may include hardware or software which manages access to a centralized resource or service in a network. A cloud may include a cluster of servers and other devices which are distributed across a network.

In some embodiments, the computing system 102 may include a first obtaining component 112, a second obtaining component 114, an approximation component 116, and an optimizing component 118. The computing system 102 may include other components. The computing system 102 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and one or more memories (e.g., permanent memory, temporary memory, non-transitory computer-readable storage medium). The one or more memories may be configured with instructions executable by the one or more processors. The processor(s) may be configured to perform various operations by interpreting machine-readable instructions stored in the memory. The computing system 102 may be installed with appropriate software (e.g., platform program, etc.) and/or hardware (e.g., wires, wireless connections, etc.) to access other devices of the system 100.

In some embodiments, the computing devices 104 and 106 may be implemented on or as various devices such as a mobile phone, tablet, server, desktop computer, laptop computer, etc. The computing system 102 may communicate with the computing devices 104 and 106, and other computing devices. Communication between devices may occur over the internet, through a local network (e.g., LAN), through direct communication (e.g., BLUETOOTH™, radio frequency, infrared), etc.

In some embodiments, the system 100 may include a risk detection platform. For example, the computing system 102 and/or other computing devices may implement the risk detection platform. The risk detection platform may include a plurality of rules for evaluating risk and effectuating its applications. These rules may be designed from empirical data or by machine learning methods. For example, the platform may obtain data (e.g., transactions associated with various features and labelled with different risk levels) from various sources, such as the computing device 104, through communications 122. The computing device 104 may have obtained or stored such data in advance or in real time. The platform may use the obtained data to build or learn risk detection (or evaluation) rules. The rules may be deployed in a remote server, cloud, client-side device, etc. For example, the computing device 106 may be installed with a software application, a web application, an Application Program Interface (API), or another suitable interface for invoking the rules.

In some embodiments, the rules may be deployed in the computing device 106 or in the server 130. The computing device 106 may obtain one or more transactions 126 from one or more devices (e.g., 140a, 140b, etc.). The one or more devices may comprise mobile phone, tablet, server, desktop computer, laptop computer, etc. For example, device 140b may be a mobile phone used to conduct a transaction (e.g., a spending transaction, a credit card application), which before being approved, is submitted to the computing device 106. The computing device 106 may apply the rules deployed in the computing device 106 or invoke the rules deployed in the server 130 through communications 124. The computing device 106 may apply the rules to the one or more transactions 126 for determining their risk levels. Based on the determined risk levels, the computing device 106 may implement follow-up steps such as approving or rejecting the transaction (e.g., through sending an instruction to a device of a bank or a seller), requiring additional verifications (e.g., sending a verification code or task to the device 140b for verifying identity), etc.

While the computing system 102 is shown in FIG. 1 as a single entity, this is merely for ease of reference and is not meant to be limiting. One or more components or one or more functionalities of the computing system 102 described herein may be implemented in a single computing device or multiple computing devices. For example, the computing system 102 may incorporate the computing device 106, or vice versa. That is, each of the first obtaining component 112, the second obtaining component 114, the approximation component 116, and the optimizing component 118 may be implemented in the computing system 102 or the computing device 106. Similarly, the computing system 102 may couple to and associate with one or more other computing devices that effectuate a portion of the components or functions of the computing system 102. The computing device 106 may comprise one or more processors and one or more memories coupled to the processors configured with instructions executable by one or more processors to cause the one or more processors to perform various steps described herein.

Various components of the system 100 may be configured to perform steps for maximizing risk detection coverage with constraint. In some embodiments, the first obtaining component 112 may be configured to obtain a plurality of historical transactions from historical information. Each of these historical transactions may have been determined by one or more risk-detection rules as risky or safe before the transaction is executed, and labeled as risky or safe according to post-transaction determination (e.g., after the transaction is executed or investigated). If a transaction was identified as risky (or safe) by a rule but labeled as safe based on the post-transaction determination, a false identification occurs. In one embodiment, a rule may comprise a plurality of conditions, such as transaction time (e.g., the date and/or time-of-the-day when the transaction is performed), transaction location (e.g., the geographical location where the transaction is performed), transaction frequency (e.g., the frequency of the same user conducting transaction, the frequency of the same type of transaction being performed), user history (e.g., how long the user has been registered with the transaction platform, user history of using services provided by the platform or other platforms), transaction amount, and risk level (e.g., risky, safe).

In some embodiments, some of the plurality of transactions are labelled as risky transactions and some of the plurality of transactions are labelled as safe transactions. “Risky” and “safe” are relative terms indicating different risk level labels. There can be more than two labels for the transactions. For example, some transactions have risk levels 9-10 (labelled as risky), some transactions have risk levels 7-8 (labelled as probably risky), some transactions have risk levels 5-6 (labelled as risk-neutral), some transactions have risk levels 3-4 (labelled as probably safe), and some transactions have risk levels 1-2 (labelled as safe). For simplicity, the embodiments in this specification assume that a transaction may be labeled either as “risky” or “safe.” In some embodiments, the technologies described herein may be expanded and applied to the use cases where multiple risk-levels are used (e.g., using different weights for misidentifications of various degrees). For example, identifying an actual risky transaction as level 1 (e.g., absolutely safe) should be treated more seriously (e.g., bearing higher weight) than identifying an actual risky transaction as level 6 (e.g., risk-neutral); similarly, identifying an actual safe transaction as level 10 (e.g., absolutely risky) should be treated more seriously (e.g., bearing higher weight) than identifying an actual safe transaction as level 6 (e.g., risk-neutral).

In some embodiments, the second obtaining component 114 may be configured to obtain an initial subset of the plurality of risk-detection rules. The initial subset may serve as a starting point for the iterative exploration process in seeking for the optimal subset with the maximum risk-detection coverage while satisfying a preset customer disruption rate. This initial subset may be determined manually or randomly. In some embodiments, the initial subset may be configured as an empty set (e.g., including 0 rule). The risk-detection coverage of the initial subset does not need to meet any requirement, but its customer disruption rate may be required to be not greater than a preset threshold. As described above, the risk-detection coverage and the customer disruption rate of the initial subset may be learned from historical data. For example, the risk-detection coverage of the initial subset may be determined based on the number of unique historical transactions that have been correctly identified as risky or safe, and the customer disruption rate of the initial subset may be determined based on the number of unique historical transactions that have been falsely identified as risky or safe. Here, the “unique” implies that if two or more rules in a subset correctly identify a risky (or safe) transaction, the transaction only counts once in determining the risk-detection coverage or customer disruption rate for the subset.

In some embodiments, the approximation component 116 may be configured to approximate the objective function g(x) and the cost function f(x) in formula (1) based on a given subset (e.g., the initial subset in the first iteration). The approximation of the objection function may be a lower-bound approximation (e.g., a lower-bound data mapping) that, for the given subset, generates an approximate risk-detection coverage for the given subset. The approximation of the cost function may be an upper-bound approximation (e.g., an upper-bound data mapping) that, for the given subset, generates an approximate customer disruption rate for the given subset. For the sake of simplicity, the lower-bound approximation of g(x) is denoted as ĝ(x), where ĝ(x)≤g(x) for any given subset x; the upper-bound approximation of f(x) is denoted as \hat{f}(x), where \hat{f}(x)≥f(x) for any given subset x.

One of the reasons for learning (x) is to reduce the search space of the original optimization problem formulated in formula (1). Also, since ĝ(x) is a lower bound of g(x), meaning ĝ(x)≤g(x), if a given set reaches a maximum risk-detection coverage in the search space of ĝ(x), it must reach a risk-detection coverage in the search space of g(x) that is at least as high as the risk-detection coverage in the search space of ĝ(x). Similarly, the reason for learning \hat{f}(x) is that, if a given set keeps its disruption rate below a preset threshold b in \hat{f}(x), its disruption rate in f(x) must be below b as well (i.e., b≥\hat{f}(x)≥f(x)).

In some embodiments, the optimizing component 118 may be configured to work with the approximation component 116 to iteratively explore for the optimal subset for maximizing the risk-detection coverage subject to a constraint. In some embodiments, one iteration may involve using the approximation component 116 to a transitional subset (e.g., estimation step), and then using the optimizing component 118 to optimize the transitional subset to learn a new subset Xₜ₊₁ for the next iteration (e.g., optimization step). The iterative process involving the approximation component 116 and the optimizing component 118 may be continued until the subset Xₜ₊₁ obtained in a new iteration is not superior to the subset Xₜ from the previous iteration.

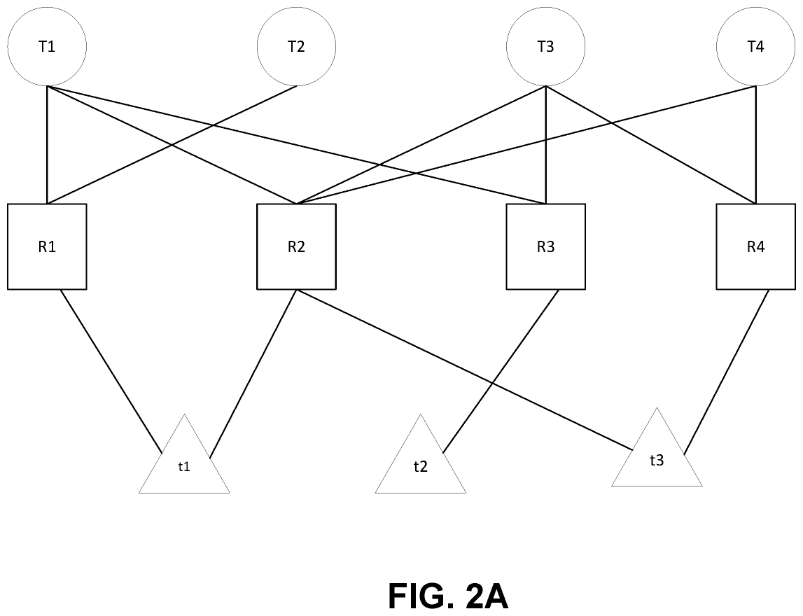

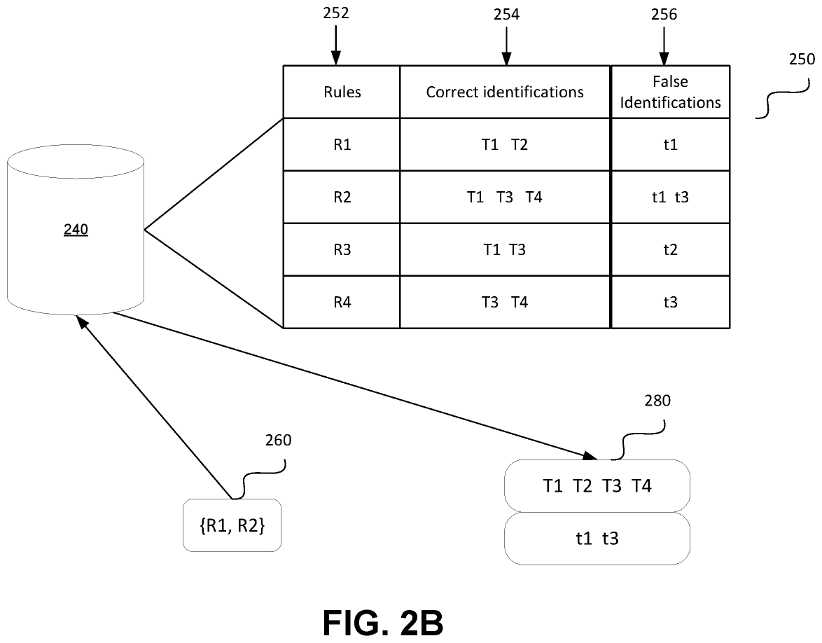

FIG. 2A illustrates an exemplary setup for maximizing risk-detection coverage in accordance with some embodiments. The setup shown in FIG. 2A may refer to a risk management system, such as a credit card application screening system where whether a credit card application should be deemed as risky or safe (e.g., risky application may lead to smaller amount of credit line), a fraud-detection system where a spending transaction or money transferring transaction may be evaluated (e.g., risky transaction may require additional authentication), or another suitable risk management system. The risk management system may be constructed from a plurality of risk-detection rules. The squares R1, R2, R3, and R4 in FIG. 2A may refer to the plurality of rules, the circles T1, T2, T3 and T4 may refer to different transactions that the rules have been correctly identified (e.g., risky transactions are identified as risky, and safe transactions are identified as safe), the triangles t1, t2, t3 and t4 may refer to different transactions that the rules have been falsely identified (e.g., risky transactions are identified as safe, and safe transactions are identified as risky). In particular, R1 has correctly identified two transactions T1 and T2, but falsely identified one transaction t1; R2 has correctly identified three transactions T1, T3, and T4, but falsely identified two transactions t1 and t3; R3 has correctly identified two transactions T1 and T3, but falsely identified a transaction t2; R4 has correctly identified two transactions T3 and T3, but falsely identified a transaction t3.

For each rule, the number of correctly identified transactions may be converted to its risk-detection coverage (may be referred to as true-positive score), and the falsely identified transactions may be converted to its customer disruption rate (may be referred to as false-positive score). For a subset of the rules comprising more than one rules, the number of correctly identified unique transactions may be converted to a risk-detection coverage of the subset, and the falsely identified unique transactions may be converted to a customer disruption rate of the subset. It may be noted that no transaction would be double counted. For example, if a subset includes rules R1 and R2, the number of correctly identified unique transactions by this subset includes T1, T2, T3 and T4. Even though both R1 and R2 correctly identified transaction T1, T1 is only counted once when determining the number of unique transactions. Similarly, for the subset comprising R1 and R2, the number of falsely identified unique transactions is 2 (e.g., the false positive for this subset comprises t1 and t3). Even though both R1 and R2 falsely identified transaction t1, t1 only needs to be counted once when determining customer disruption rate for the subset comprising R1 and R2. In some embodiments, not only the number of unique transactions is considered, different transactions may be assigned different weights (e.g., a completely mistaken identification may be assigned higher weight for penalty, a minor misidentification may be assigned lower weight). This specification does not limit the way how the numbers are converted to the coverage or rate. For simplicity, the following description directly uses the number of unique transactions correctly or falsely identified by a given subset as its risk-detection coverage or customer disruption rate, respectively.

The task to be solved by the embodiments in this specification is to determine a subset (e.g., may be empty, a portion of the rules, or all the rules) to maximize its risk-detection coverage while being subject to a constraint on its customer disruption rate (e.g., the number of falsely identified transactions may not exceed 2).

FIG. 2B illustrates an exemplary data querying system for maximizing risk-detection coverage in accordance with some embodiments. As mentioned above, for a given single rule or a given subset of a plurality of risk-detection rules, the corresponding risk-detection coverage and customer disruption rate may be learned from historical information. The historical information may include historical transactions that the rules have been applied to. Each historical transaction may have been identified by multiple rules, and each rule may have been applied to multiple transactions. The historical information may be collected from a preset period of time.

Referring to FIG. 2B, a server 240 may be configured to store the historical information, and respond to queries about risk-detection coverage and customer disruption rate of a given singular rule or a group of rules. Even though the server 240 in FIG. 2B is shown as one single entity, it may comprise a plurality of entities depending on the implementation. For example, it may include a database (e.g., centralized or distributed) to store the data, and a computing system to respond to the queries (e.g., serving as an oracle).

In some embodiments, the historical information may be logically organized as table 250. The first column 252 of table 250 lists the rules, the second column 254 of table 250 lists the historical transactions that have been correctly identified by each of the rules, and the third column 256 of the table 260 lists the historical transactions that have been falsely identified by each of the rules. The content of table 250 in FIG. 2B corresponds to the exemplary setup shown in FIG. 2A. It may be appreciated that the table 250 is a logical view of the historical information, the actual layout of the database may be implemented in various ways depending on the structure of the storage system (e.g., centralized, distributed across multiple storage nodes, or cloud-based storage service).

In FIG. 2B, an exemplary query 260 is sent to the server 240 comprising a pair of rules {R1, R2}. In response, the server 240 returns an exemplary response 280 comprising two fields: a first field comprising the unique historical transaction IDs that {R1, R2} have correctly identified (e.g., in this case, T1˜T4, 4 transactions), and the second field comprising the unique historical transaction IDs that {R1, R2} have falsely identified (e.g., in this case, t1 and t3, 2 transactions). In some embodiments, the response may comprise richer information besides the transaction IDs. For example, each transaction's actual label (e.g., manually verified risk rating) and the evaluation (e.g., predicted risk rating) by each rule that has applied to this transaction may be returned. The response may be the basis to determine the risk-detection coverage and customer disruption rate for the given group of rules (e.g., {R1, R2} in the case shown in FIG. 2B).

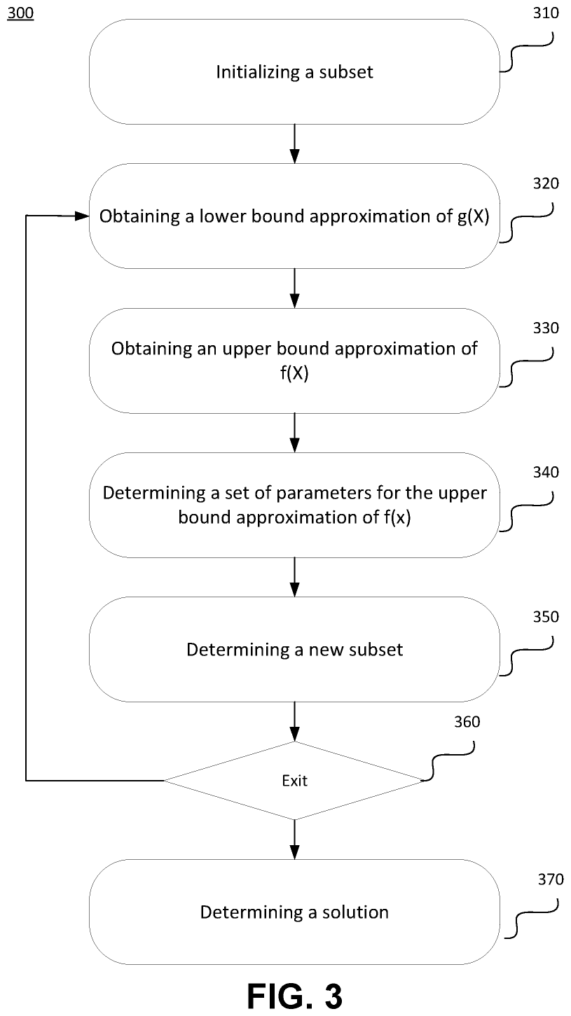

FIG. 3 illustrates an exemplary method 300 for maximizing risk-detection coverage in accordance with some embodiments. The method 300 in FIG. 3 is intended to be illustrative, which may include fewer, more, or alternative steps as shown in FIG. 3 depending on the implementation. The method 300 may be implemented by the computing system 102 in FIG. 1, and applied to the problem illustrated in FIG. 2A and 2B.

As shown, the method 300 may include an iterative exploration seeking for a subset of a plurality of risk-detection rules to deploy for risk-detection on future transactions. The plurality of risk-detection rules may be understood as a pool of candidates, and the subset may comprise a portion or all of the candidates. The subset to be selected from the candidates may form an optimal solution to maximize the risk-detection coverage while being subject to a constraint on customer disruption rate.

In some embodiments, the method 300 may start with step 310 by obtaining a first subset of a plurality of risk-detection rules, the first subset being associated with a first coverage score, where the first coverage score indicates a number of unique historical transactions that have been correctly identified by the plurality of risk-detection rules in the first subset.

For example, step 310 in FIG. 3 includes initializing a subset of a plurality of risk-detection rule. This initialized subset may be manually selected or randomly generated. It may serve as a starting point of the iterative process of method 300. There is no requirement of the risk-detection coverage (e.g., a number of unique historical transactions that have been correctly identified by the plurality of risk-detection rules in the initial subset) provided by the initial subset, but the customer disruption rate associated with the initial subset may need to be smaller than a preset threshold. In some embodiments, the initial subset may be empty, since the customer disruption rate associated with an empty subset may be considered as 0, which is smaller than any given positive threshold.

In some embodiments, step 320 of the method 300 may comprise constructing, based on the first subset, a lower-bound data mapping that outputs an approximate coverage score for an input subset, wherein: when the input subset is the first subset, the approximate coverage score is the same as the first coverage score, and when the input subset is a second subset different from the first subset and corresponds to a second coverage score indicating a number of unique historical transactions that have been correctly identified by risk-detection rules in the second subset, the approximate coverage score is not greater than the second coverage score.

In some embodiment, the lower-bound approximation, denoted as ĝ(x), may be a submodular and monotonic function determined by following steps: generating a sequence by reordering the plurality of risk-detection rules, wherein risk-detection rules in the first subset are placed first in the sequence; based on the generated sequence, constructing a list of temporal subsets Sᵢ, 0≤i≤n, where: n is a quantity of the plurality of risk-detection rules, temporal subset S₀ is empty, and for a given i where 1≤i≤n, temporal subset Sᵢ comprises an iₜₕ risk-detection rule in the sequence and all risk-detection rules in temporal subset Sᵢ₋₁; and determining the approximate coverage score for each risk-detection rule in the sequence; and learning a variational approximation function to determine a coverage score for a given subset of the plurality of risk-detection rules based on a summation of the approximate individual coverage score of each risk-detection rule in the given subset.

For example, assuming the current iteration is the tₜₕ iteration, and the subset is Xₜ (e.g., the known subset), a permutation π of the risk-detection rules [n] may be determined by placing the elements in Xₜ first and then includes the remaining rules in [n] (e.g., excluding the elements in Xₜ). The permutation π may be understood as a sequence denoted as {π₁, π₂, . . . πₙ} by reordering the plurality of risk-detection rules in [n]. For example, if Xₜ comprises [rule1, rule2], π₁ in the sequence may be {rule1}, and π₂ may be {rule2} (e.g., placing the rules in Xₜ first in the sequence).

Then a list of temporal subsets may be constructed based on the sequence in the following ways:

S₀^{π}=empty, S₁^{π={π}₁}, S₂^{π}={π₁, π₂}, . . . , Sₙ^{π}={π₁, . . . , πₙ}

which results in S₀^{π}⊂S₁^{π⊂S}₂^{π} . . . ⊂Sₙ^{π}=[n]. Then the ĝ(x) for a given subset X may be given by

ĝ_{X}_{ₜ}^{π}(X)=Σ_{jϵX}ĝ_{X}_{ₜ}^{π}(j), ∀X⊂[n] (2)

where j is any risk-detection rule in the given subset X, and X is a subset of the plurality of risk-detection rules [n]. The above formula may be understood as: the value of ĝ_{X}_{ₜ}^{π}(X) for the given subset Xis the sum of the value ĝ_{X}_{ₜ}^{π}(j) on each risk-detection rule j in the subset X. In some embodiments, the determining the approximate individual coverage score ĝ_{X}_{ₜ}^{π}(j) for each risk-detection rule j in the sequence comprises: for the iₜₕ risk-detection rule in the sequence, determining an approximate individual coverage score based on a difference between a coverage score of the temporal subset Sᵢ and a coverage score of the temporal subset Sᵢ₋₁, where the coverage score of the temporal subset Sᵢ and the coverage score of the temporal subset Sᵢ₋₁ are learned by querying the database of historical transactions

For example, the ĝ_{X}_{ₜ}^{π}(j) with j=πᵢSᵢ^{π}−Sᵢ₋₁^{π} may be defined by:

ĝ_{X}_{ₜ}^{π}(j)=ĝ_{X}_{ₜ}^{π}(Sᵢ^{π}−Sᵢ₋₁^{π})=g(Sᵢ^{π)-}g(Sᵢ₋₁^{π})

where the values of g(Sᵢ^{π}) and g(Sᵢ₋₁^{π}) may be obtained by examining historical transactions. For example, since the rules in Sᵢ^{π} are known, the number of unique transactions that have been correctly identified (e.g., as risky transaction) by the rules in the Sᵢ^{π} may be learned by querying historical information, and g(Sᵢ^{π}) may then be determined based on the learned number.

As shown in FIG. 3, g(X) at step 320 may refer to a black box service that takes in a given group of rules (as input X) and provides the corresponding risk-detection coverage (as output). For example, the value of g(X) for a given group of rules may be queried by using the server 240 in FIG. 2B that takes in an input query 260 comprising a group of rules and generates a response 280 comprising the unique transactions correctly identified by the group of rules and the unique transactions falsely identified by the group of rules. The unique transactions correctly identified by the group of rules may be used to determine the risk-detection coverage of the group of rules. The lower bound approximation of g(x) is learned during each iteration and based on the input subset (e.g., the initial subset for the first iteration).

In some embodiments, step 330 of the method 300 may comprise constructing, based on the first subset, an upper-bound data mapping with a set of parameters, wherein: the upper-bound data mapping outputs an approximate disruption score for the input subset of the plurality of risk-detection rules, when the input subset is the first subset, the output approximate disruption score is the same as the first disruption score, and when the input subset is the second subset different from the first subset and is associated with a second disruption score indicating a number of unique historical transactions that have been falsely identified as risky transactions by risk-detection rules in the second subset, the output approximate disruption score is not less than the second disruption score.

The following section illustrates an exemplary method to obtain the upper-bound approximation of the cost function f(x). In some embodiments, because the cost function f(x) is a submodular function, it satisfies:

f(X)+f(Y)≥f(X∪Y)+f(X∩Y) (3)

where X and Y refer to two different subsets of the plurality of risk-detection rules, X U Y refers to the union of X and Y, and X∩Y refers to the intersection of X and Y. The above formula may be interpreted as: even though X+Y =X↔Y+X∩Y, f(X)+f(Y) is greater than f(X↔Y)+f(X∩Y) as the marginal benefit of adding f(X∩Y) to f(X↔Y) is decreasing because of the submodularity of f(x). The formula (3) may be rewritten in the following format:

$$f ( X ) - {\sum }_{j ∈ X \backslash Y} f ( j \vert X \backslash j ) + {\sum }_{j ∈ Y \backslash X} f ( j \vert θ ) \geq f ( Y ) \qquad ( 4 )$$

where θ=X∩Y refers to the intersection of X and Y, “X\Y” refers to the elements (e.g., rules) in X but not in Y, “Y\X” refers to the elements (e.g., rules) in Y but not in X, “f(j|X\j)” refers to a marginal cost (e.g., increase of customer disruption rate) by adding a rule j to subset X without j (e.g., X\j equals to X if X does not include j, but equals to X excluding j if X includes j), and f(j|θ) refers to a marginal cost (e.g., increase of customer disruption rate) by adding a rule j to θ, which is X∩Y.

Based on formula (4), the upper-bound approximation of the cost function f(x) may be represented as the following formula:

b≥\hat{f}_{X}_{ₜ}(Xₜ₊₁l ; θ)=f(Xₜ)−Σ_{jϵX}_{ₜ}_{\X}_{ₜ₊₁}f(j|Xₜ\j)+Σ_{jϵX}_{ₜ₊₁}_{\X}_{ₜ}f(j|θ)≥f(Xₜ₊₁) (5)

where b is a present threshold of the customer disruption rate, Xₜ and Xₜ₊₁ refer to a solution candidate (e.g., a subset) at iteration t and a solution candidate at iteration t+1 respectively, \hat{f}_{X}_{ₜ}( ) refers to the upper-bound approximation of the cost function f(x) constructed based on Xₜ at iteration t (e.g., it implies that \hat{f}_{X}_{ₜ}( ) needs to be updated in each iteration), \hat{f}_{X}_{ₜ}(xₜ₊₁; θ) refers to an approximate customer disruption rate generated for the solution candidate Xₜ₊₁, where θ=Xₜ∩Xₜ₊₁ may be understood as a set of parameters that \hat{f}_{X}_{ₜ}( ) uses. In formula (5), the \hat{f}_{X}_{ₜ}−Σ_{jϵX}_{ₜ}_{\X}_{ₜ₊₁}f(j|Xₜ\j)+Σ_{jϵX}_{ₜ₊₁}_{\X}_{ₜ}f(j|θ) is a breakdown of \hat{f}_{X}_{ₜ}( ) according to formula (4). In the formula (4), it is presumed that the current iteration is t, where Xₜ is known and Xₜ₊₁ is unknown and to be explored. As a result, the portion “f(Xₜ)−Σ_{jϵX}_{ₜ}_{\X}_{ₜ₊₁}f(j|Xₜ\j)” are all known constants, while the portion “Σ_{jϵX}_{ₜ₊₁}_{\X}_{ₜ}f(j|θ)” is unknown and to be explored. In other words, in order to determine the value of \hat{f}_{X}_{ₜ}(Xₜ₊₁; θ) for Xₜ₊₁, θ needs to be learned or estimated. Here, θ may be understood as a set of parameters that \hat{f}_{X}_{ₜ}(Xₜ₊₁; θ) uses.

Referring back to formula (5), even though \hat{f}_{X}_{ₜ}(Xₜ₊₁; θ) is an upper-bound of f(Xₜ₊₁) (e.g., b≥\hat{f}_{X}_{ₜ}(Xₜ₊₁; θ) >f(Xₜ₊₁)), it is desirable to keep them as close as possible. An analogy to explain the above statement is “for a given budget b, it is desirable to keep the spending as close to b as possible in order to maximize the gain.” In some embodiments, Nemhauser divergence may be used to represent the difference between \hat{f}_{X}_{ₜ}(Xₜ₊₁; θ) and f(Xₜ₊₁), as shown in the following formula:

D(\hat{f}_{X}_{ₜ}(Xₜ₊₁; θ)≥f(Xₜ₊₁) (7)

where D stands for divergence, e.g., the difference between \hat{f}_{X}_{ₜ}(Xₜ₊₁; θ) and f(Xₜ₊₁).

With above-mentioned denotations, the task of constructing an upper-bound approximation (e.g., data mapping) for f(Xₜ₊₁) may be transformed to a task as: finding aθ that minimizes D(\hat{f}_{X}_{ₜ}(Xₜ₊₁; θ)|f(Xₜ₊₁)). Since θ=Xₜ∩Xₜ₊₁ (where Xₜ is known and Xₜ₊₁ is unknown), after θ is obtained, Xₜ₊₁ (i.e., the subset for the next iteration t+1) may be determined.

As shown in FIG. 3, f(x) at step 330 may refer to a block box service that takes in a given group of rules (as input) and provides the corresponding customer disruption rate (as output). For example, f(x) may be learned based on the server 240 in FIG. 2B that takes in an input query 260 comprising a group of rules and generates a response 280 comprising the unique transactions correctly identified by the group of rules and the unique transactions falsely identified by the group of rules. The unique transactions falsely identified by the group of rules may be used to determine the customer disruption of the group of rules. The upper bound approximation of f(x) may refer to \hat{f}_{X}_{ₜ}(Xₜ₊₁; θ) of formula (5) in the text accompanying FIG. 1. The upper bound approximation of f(x) is learned during each iteration and based on the input subset (e.g., the initial subset for the first iteration). In \hat{f}_{X}_{ₜ}(Xₜ₊₁; θ), θ may be understood as a set of parameters for \hat{f}_{X}_{ₜ}. Once θ is estimated, it may be used to estimate a new subset for the next iteration.

At step 340, the set of parameters θ for the upper bound approximation of f(x) may be determined. An exemplary way to determine θ may comprise: for each of the plurality of risk-detection rules: determining a first approximate coverage score based on the lower-bound data mapping; determining a first disruption score increase associated with adding the each risk-detection rule to a first group of risk-detection rules based on a number of unique historical transactions that have been falsely identified by the each risk-detection rule; and determining a first ratio for the each risk-detection rule, wherein the approximate coverage score is a numerator and the first disruption score increase is a denominator; and generating a sequence by sorting the plurality of risk-detection rules in a descending order according to the determined first ratios of the plurality of risk-detection rules; selecting a maximum number of risk-detection rules with a first overall disruption score increases being not greater than the preset threshold, wherein the first overall disruption score is a summation of the first disruption score increases associated with the selected risk-detection rules; and determining the set of parameters as an intersection of the first subset and the selected risk-detection rules.

For example, at tₜₕ iteration with the known subset Xₜ, θ may be determined by the following steps. To simplify the description, E\j may be defined as a set that excludes j, i.e.,

$$E \backslash j = \{ \begin{matrix}{X}_{t} \backslash j , & if j ∈ {X}_{t} \\ {X}_{t} , & if j ∉ {X}_{t}\end{matrix}$$

The above denotation may be understood as: for a given j, if j is in the subset Xₜ, E\j equals to Xₜ but excluding j; if j is not in the subset Xₜ, E\j equals to the subset Xₜ.

For each of the plurality of rules in [n], the approximate coverage score may be determined by ĝ_{X}_{ₜ}(j), and the corresponding disruption score may be determined based on f(j|E\j) (e.g., the disruption rate increase by adding j into the subset E\j). Then, a ratio may be determined for each of the rule as

$$\frac{{\hat{g}}_{{X}_{t}} ( j )}{f ( j \vert E \backslash j )} .$$

According to determined ratios for all the rules in [n], the rules may be sorted as {ϵ₁, ϵ₂, . . . , ϵₙ} in a descending order such that:

$$\frac{{\hat{g}}_{{X}_{t}} ( {ϵ}_{1} )}{f ( {ϵ}_{1} \vert E \backslash {ϵ}_{1} )} \geq \frac{{\hat{g}}_{{X}_{t}} ( {ϵ}_{2} )}{f ( {ϵ}_{2} \vert E \backslash {ϵ}_{2} )} \geq ⋯ \geq \frac{{\hat{g}}_{{X}_{t}} ( {ϵ}_{n} )}{f ( {ϵ}_{n} \vert E \backslash {ϵ}_{n} )}$$

where ϵ refers to a rule in the plurality of risk-detection rules [n]. There exists a \hat{k} such that \hat{k}=argmaxₖΣ_{k′=1}^{k}f(ϵ_{k′}|E\ϵ_{k′})≤b, where b is the preset threshold for the customer disruption rate. \hat{k} here refers to the maximum number of the risk-detection rules that provides an overall customer disruption rate increases (e.g., Σ_{k′}^{k}f(ϵ_{k′}|E\ϵ_{k′})) that is smaller than b.

Based on the sorted sequence {ϵ₁, ϵ₂, . . . , ϵₙ} and the value \hat{k}, the set of parameters δ in formula (5) may be estimated as

\hat{θ}=Xₜ∩{ϵ₁, ϵ₂, . . . ϵ_{\hat{k}}} (8)

where ∩ refers to an intersection operation. The \hat{θ}ₜ refers to an estimation of the true value of θ at iteration t, and may be used to improve the current subset Xₜ to obtain a new subset Xₜ₊₁ in the next iteration (e.g., the t+1ₜₕ iteration).

At step 350, the new subset for the next iteration may be determined. An exemplary way to determine the new subset may comprise: sorting the plurality of risk-detection rules based on the first subset, the set of parameters, and the approximate coverage scores generated by the lower-bound data mapping for the plurality of risk-detection rules; and from a beginning of the sorted plurality of risk-detection rules, selecting one or more consecutive risk-detection rules as the third subset. In some embodiments, the sorting the plurality of risk-detection rules may comprise: for each of the plurality of risk-detection rules: determining a second approximate coverage score based on the lower-bound data mapping; determining a second group of risk-detection rules as the set of parameters if the each risk-detection rule is not in the first subset, or as the first subset excluding the each risk-detection rule if the each-detection rule is in the first subset; determining a second disruption score increase associated with adding the each risk-detection rule to the second group of risk-detection rules; and determining a second ratio for the each risk-detection rule, wherein the second approximate coverage score is a numerator and the second disruption score increase is a denominator; and generating a sequence by sorting the plurality of risk-detection rules in a descending order according to the second ratio of the each risk-detection rule; and selecting a maximum number of risk-detection rules with a second overall disruption score increases being not greater than the preset threshold, wherein the second overall disruption score is a sum of the second disruption score increases associated with the selected risk-detection rules.

For example, the optimizing component 118 may learn the new subset Xₜ₊₁ for the t+1ₜₕ iteration by following steps. Denoting a set without j for the given subset Xₜ as:

$$M \backslash j = \{ \begin{matrix}{X}_{t} \backslash j , & if j ∈ {X}_{t} \\ {\hat{θ}}_{t} , & if j ∉ {X}_{t}\end{matrix}$$

The above denotation may be understood as: for a given j, if j is in the subset Xₜ, M\j equals to Xₜ but excluding j; if j is not in the subset Xₜ, M\j equals to the estimated \hat{θ}ₜ.

$$\frac{{\hat{g}}_{{X}_{t}} ( j )}{f ( j \vert M \backslash j )} ,$$

For each of the plurality of risk-detection rules, a ratio may be determined as where j refers to a single rule. According to determined ratios for all the rules in [n], the rules may be sorted as {μ₁, μ₂, . . . μₙ} in a descending order such that:

$$\frac{{\hat{g}}_{{X}_{t}} ( {μ}_{1} )}{f ( {μ}_{1} \vert M \backslash {μ}_{1} )} \geq \frac{{\hat{g}}_{{X}_{t}} ( {μ}_{2} )}{f ( {μ}_{2} \vert M \backslash {μ}_{2} )} \geq ⋯ \geq \frac{{\hat{g}}_{{X}_{t}} ( {μ}_{n} )}{f ( {μ}_{n} \vert M \backslash {μ}_{n} )}$$

By letting \hat{m} be the maximum index that satisfy the following inequality:

$$\hat{m} = {argmax}_{m} {\sum }_{{m}^{′} = 1}^{m} f ( {μ}_{{m}^{′}} \vert M \backslash {μ}_{{m}^{′}} ) \leq b$$

where b is the preset threshold for the customer disruption rate. \hat{m} here refers to the maximum number of the risk-detection rules that provides an overall customer disruption rate increases (e.g., Σ_{m′=1}^{m}f(μ_{m′}|M\μ_{m′})) that is smaller than b. Based on \hat{m}, Xₜ₊₁ may be determined for the next iteration as:

{μ₁, μ₂, . . . , μ_{\hat{m}}} (9)

At step 360, the new subset generated at step 350 may be compared to the old subset (e.g., the initial subset at the first iteration) to determine if the iterative process may be terminated. In some embodiments, the exit condition at step 360 may include whether the new subset's risk-detection coverage is equal to or greater than the old subset's risk-detection coverage. If so, it means the new subset is a better solution than the old subset, which means the iterative process may continue to find the next better solution; if not, it means a better solution may not be found, and thus the iterative process may terminate.

At step 370, once the exit condition at step 360 is met, a final solution may be determined as the subset with the maximized risk-detection coverage from the ones that have been explored by the iterative process.

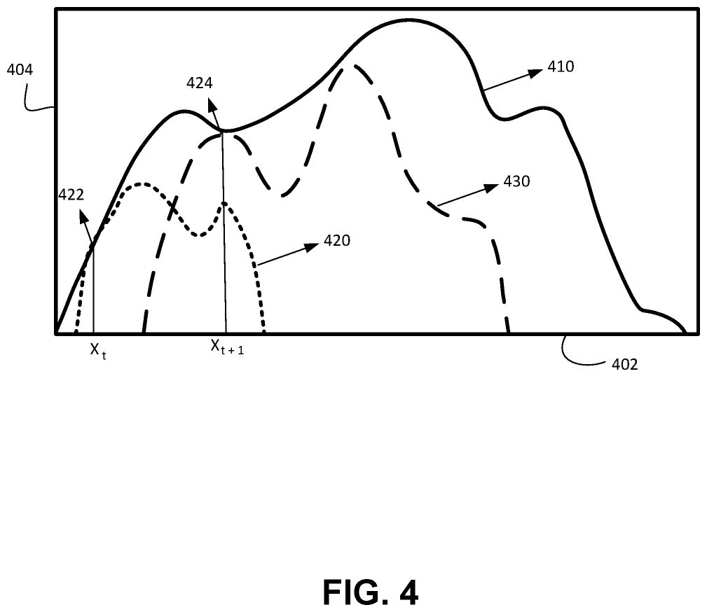

During the iterative method 300, all the subsets being explored are guaranteed to have a customer disruption rate below the preset threshold because of the way the lower-bound approximation and upper-bound approximation are constructed. FIG. 4 visualizes the process for a better understanding.

FIG. 4 illustrates an exemplary diagram for maximizing risk-detection coverage in accordance with some embodiments. The diagram in FIG. 4 involves two iterations of the iterative process illustrated in FIG. 3: iteration t and iteration t+1. The X-axis 402 in FIG. 4 represents different subsets of the risk-detection rule candidates. Assuming there are n candidates, the total number of different subsets is 2ⁿ. Each point/dot on the X-axis 402 may refer to one of the 2ⁿ subsets that has a customer disruption rate below the preset threshold. The Y-axis 404 in FIG. 4 represents the risk-detection coverage corresponding to each of the point/dot on the X-axis 402. The solid line curve 410 in FIG. 4 represents the entire collection of risk-detection coverages of all the subsets (e.g., points on the X-axis) that have customer disruption rates below the preset threshold. In some embodiments, when the number of rule candidates is large, the number of subsets may become enormous. It may not be practical to enumerate all the valid subsets in order to determine the optimal one (the problem has been approved as an NP hard problem). This is the reason why the iterative method 300 in FIG. 3 becomes necessary.

As shown in FIG. 4, Xₜ refers to a known subset at iteration t, and the goal is to search for a new subset Xₜ₊₁ for the next iteration t+1. It may be understood that during the first iteration, Xₜ refers to the initial subset determined at step 310 in FIG. 3. For the subset Xₜ, the corresponding risk-detection coverage may refer to the point 422 on the solid line 410.

The dot line 422 may refer to the lower-bound approximation of the solid line 410. The solid line 410 may refer to g(x) in formula (EE1) (e.g., the objective function) and the dot line 422 may refer to the lower-bound approximation of g(X), denoted as ĝ_{X}_{ₜ}(X) in formula (3). As shown in FIG. 4, ĝ_{X}_{ₜ}(X) is always below g(X), except that at point Xₜ, both ĝ_{X}_{ₜ}(X) and g(X) yield the same risk-detection coverage (e.g., point 422).

Based on ĝ_{X}_{ₜ}(X) and Xₜ, the set of parameters θ for the upper bound approximation of f(X) may be determined. After θ is determined, Xₜ₊₁ may be determined based on formula (9) (detailed process is explained in the accompanying description of formula (9)). As shown in FIG. 4, Xₜ₊₁ may be projected to point 424 on g(X) (the solid line 410). Because the point 424 corresponding to the subset Xₜ₊₁ may have a higher risk-detection coverage than point 422 corresponding to the subset Xₜ, the iterative process may continue.

At iteration t+1, a new lower-bound approximation constructed based on Xₜ₊₁ may be represented as the new dot line 430, i.e., ĝ_{X}_{ₜ₊₁}(X). As shown, the new dot line 430 ĝ_{X}_{ₜ₊₁}(X) is always below g(X), except for the Xₜ₊₁ point on the X-axis, where ĝ_{X}_{ₜ₊₁}(Xₜ₊₁) and g(Xₜ₊₁) both yield a risk-detection coverage denoted as point 424. Subsequently, a new set of parameters θ for the upper bound approximation of f(X) may be determined. After θ is determined, Xₜ₊₂ may be determined based on formula (9). The iterative process may continue until the newly found subset has a lower risk-detection coverage than the previous subset.

The method disclosed herein may be applicable to other use cases where a representative subset of a plurality of candidates needs to be selected to achieve an objective while satisfying a constraint. For example, in the field of image collection summarization, a group of images (the representative subset) may be identified from an enormously large number of image candidates (denoted as a ground set), to achieve an objective (e.g., to represent the desired features of the images in the group set) while being subject to certain constraints (e.g., the number of images in the representative subset may not be more than a preset number, or the total size of the image files must be smaller than a preset size). In this aspect, the specification provides a general method which includes obtaining a first subset of a plurality of candidates (e.g., an initial version of the representative subset, which may be iteratively improved using the disclosed method), the first subset being associated with a first true-positive score and a first false-positive score. The first true-positive score indicates a gain associated with candidates in the first subset (e.g., in the context of image collection summarization, the first true-positive score may be determined based on the distinguished features it covers), and the first false-positive score indicates a cost associated with candidates in the first subset (e.g., in the context of image collection summarization, the first false-positive score may be determined based on the unwanted features that covered by the images in the first subset). The method may further include constructing, based on the first subset, a lower-bound data mapping that outputs an approximate true-positive score for an input subset. When the input subset is the first subset, the approximate true-positive score is the same as the first true-positive score, and when the input subset is a second subset different from the first subset, the approximate true-positive score is not greater than a second true-positive score associated with the second subset, the second true-positive score indicating a gain associated with candidates in the second subset. The method may further include constructing, based on the first subset, an upper-bound data mapping comprising a set of parameters. The upper-bound data mapping outputs an approximate false-positive score for the input subset of the plurality of candidates. When the input subset is the first subset, the output approximate false-positive score is the same as the first false-positive score, and when the input subset is the second subset different from the first subset, the output approximate false-positive score is not less than a second false-positive score associated with the second subset, the second false-positive score indicating a gain associated with candidates in the second subset. The method may further include, according to the first subset, the lower-bound data mapping, and the upper-bound data mapping, generating a third subset of the plurality of candidates based at least on: the approximate true-positive scores output by the lower-bound data mapping corresponding to the plurality of candidates as inputs, and the set of parameters associated with the upper-bound data mapping. The third subset is associated with a third true-positive score indicating a gain associated with the plurality of candidates in the third subset. The method may further include comparing the first true-positive score with the third true-positive score, and in response to the first true-positive score exceeding the third true-positive score, selecting candidates in the first subset for on a new transaction.

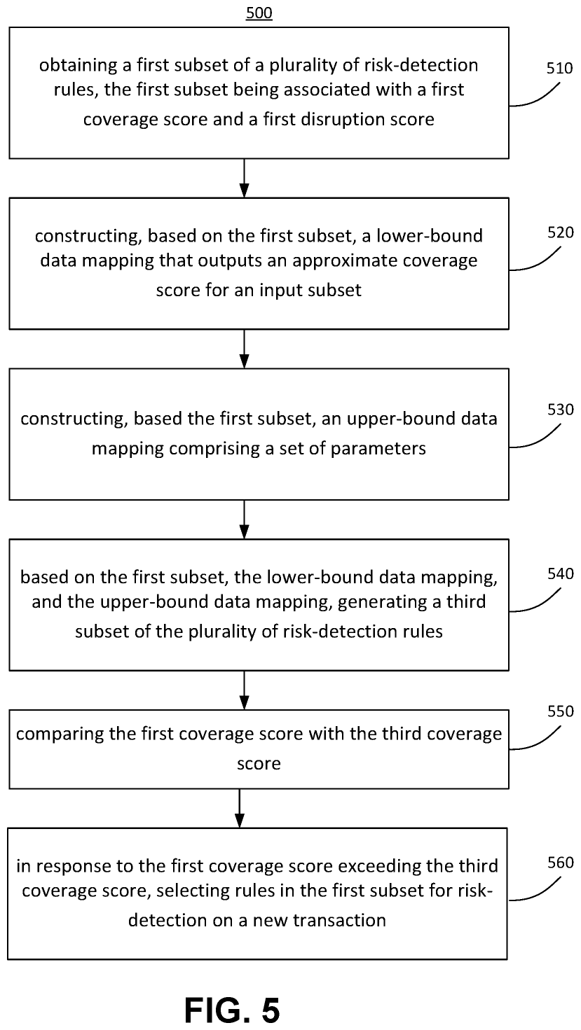

FIG. 5 illustrates an example method for risk detection, in accordance with various embodiments. The method 500 may be performed by a device, apparatus, or system for risk detection. The method 500 may be performed by one or more modules/components of the environment or system illustrated by FIGS. 1-4, such as the computing system 300 in FIG. 3. The operations of the method 500 presented below are intended to be illustrative. Depending on the implementation, the method 500 may include additional, fewer, or alternative steps performed in various orders or in parallel.

Block 510 includes obtaining a first subset of a plurality of risk-detection rules, the first subset being associated with a first coverage score and a first disruption score. In some embodiments, the first coverage score indicates a number of unique historical transactions that have been correctly identified by the plurality of risk-detection rules in the first subset, and the first disruption score indicates a number of unique historical transactions that have been falsely identified by the plurality of risk-detection rules in the first subset.

Block 520 includes constructing, based on the first subset, a lower-bound data mapping that outputs an approximate coverage score for an input subset. In some embodiments, when the input subset is the first subset, the approximate coverage score is the same as the first coverage score, and when the input subset is a second subset different from the first subset, the approximate coverage score is not greater than a second coverage score associated with the second subset, the second coverage score indicating a number of unique historical transactions that have been correctly identified by risk-detection rules in the second subset. In some embodiments, the lower-bound data mapping comprises a submodular and monotonic function. In some embodiments, the first subset is empty. In some embodiments, the constructing a lower-bound data mapping comprises: generating a sequence by reordering the plurality of risk-detection rules, wherein risk-detection rules in the first subset are placed first in the sequence; based on the generated sequence, constructing a list of temporal subsets Sᵢ, 0≤i≤n, wherein: n is a quantity of the plurality of risk-detection rules, temporal subset S₀ is empty, and for a given i where 1≤i≤n, temporal subset Sᵢ comprises an iₜₕ risk-detection rule in the sequence and all risk-detection rules in temporal subset Sᵢ₋₁; determining the approximate coverage score for each risk-detection rule in the generated sequence; and determining a coverage score for a given subset of the plurality of risk-detection rules as a sum of the approximate individual coverage score of each risk-detection rule in the given subset. In some embodiments, the determining the approximate individual coverage score for each risk-detection rule in the sequence comprises: for the iₜₕ risk-detection rule in the sequence, determining an approximate individual coverage score based on a difference between a coverage score of the temporal subset Sᵢ and a coverage score of the temporal subset Sᵢ₋₁, wherein the coverage score of the temporal subset Sᵢ and the coverage score of the temporal subset Sᵢ₋₁ are learned by querying the database of historical transactions.

Block 530 includes constructing, based on the first subset, an upper-bound data mapping comprising a set of parameters. In some embodiments, the upper-bound data mapping outputs an approximate disruption score for the input subset of the plurality of risk-detection rules, when the input subset is the first subset, the output approximate disruption score is the same as the first disruption score, and when the input subset is the second subset different from the first subset, the output approximate disruption score is not less than a second disruption score associated with the second subset, the second disruption score indicating a number of unique historical transactions that have been falsely identified as risky transactions by risk-detection rules in the second subset. In some embodiments, the constructing an upper-bound data mapping with a set of parameters comprises determining the set of parameters by: for each of the plurality of risk-detection rules: determining a first approximate coverage score based on the lower-bound data mapping; determining a first disruption score increase associated with adding the each risk-detection rule to a first group of risk-detection rules based on a number of unique historical transactions that have been falsely identified by the each risk-detection rule; and determining a first ratio for the each risk-detection rule, wherein the approximate coverage score is a numerator and the first disruption score increase is a denominator; generating a sequence by sorting the plurality of risk-detection rules in a descending order according to the determined first ratios of the plurality of risk-detection rules; selecting a maximum number of risk-detection rules with a first overall disruption score increases being not greater than the preset threshold, wherein the first overall disruption score is a summation of the first disruption score increases associated with the selected risk-detection rules; and determining the set of parameters as an intersection of the first subset and the selected risk-detection rules. In some embodiments, the first group is determined as the first subset if the each risk-detection rule is not in the first subset, or as the first subset excluding the each risk-detection rule if the each risk-detection rule is in the first subset.

Block 540 includes according to the first subset, the lower-bound data mapping, and the upper-bound data mapping, generating a third subset of the plurality of risk-detection rules based at least on: the approximate coverage scores output by the lower-bound data mapping corresponding to the plurality of risk-detection rules as inputs, and the set of parameters associated with the upper-bound data mapping. In some embodiments, the third subset is associated with a third coverage score indicating a number of unique historical transactions that have been correctly identified by the plurality of risk-detection rules in the third subset. In some embodiments, the generating a third subset of the plurality of risk-detection rules comprises: sorting the plurality of risk-detection rules based on the first subset, the set of parameters, and the approximate coverage scores generated by the lower-bound data mapping for the plurality of risk-detection rules; and from a beginning of the sorted plurality of risk-detection rules, selecting one or more consecutive risk-detection rules as the third subset. In some embodiments, the sorting the plurality of risk-detection rules comprises: for each of the plurality of risk-detection rules: determining a second approximate coverage score based on the lower-bound data mapping; determining a second group of risk-detection rules as the set of parameters if the each risk-detection rule is not in the first subset, or as the first subset excluding the each risk-detection rule if the each-detection rule is in the first subset; determining a second disruption score increase associated with adding the each risk-detection rule to the second group of risk-detection rules; and determining a second ratio for the each risk-detection rule, wherein the second approximate coverage score is a numerator and the second disruption score increase is a denominator; generating a sequence by sorting the plurality of risk-detection rules in a descending order according to the second ratio of the each risk-detection rule; and wherein the selecting one or more consecutive risk-detection rules as the third subset comprises: selecting a maximum number of risk-detection rules with a second overall disruption score increases being not greater than the preset threshold, wherein the second overall disruption score is a sum of the second disruption score increases associated with the selected risk-detection rules.

Block 550 includes comparing the first coverage score with the third coverage score.

Block 560 includes in response to the first coverage score exceeding the third coverage score, selecting rules in the first subset for risk-detection on a new transaction.

In some embodiments, the method 500 may further comprise: in response to the first coverage score not exceeding the third coverage score, replacing the first subset with the third subset as an updated first subset, wherein the first coverage score is correspondingly replaced with the third coverage score of the third subset; cyclically performing one or more iterations of a process based on the constructing step and the generating step until an exit condition is met, the process comprising: updating, based on the updated first subset, the lower-bound data mapping; generating, based on the updated first subset and the updated lower-bound data mapping, an updated third subset associated with an updated third coverage score; and if the exit condition is not met, replacing the updated first subset with the updated third subset, and the updated first coverage score with the updated third coverage score. In some embodiments, the exit condition comprises at least one of following: the updated first coverage score being greater than the updated third coverage score, and a number of the one or more iterations being greater than a preset number.

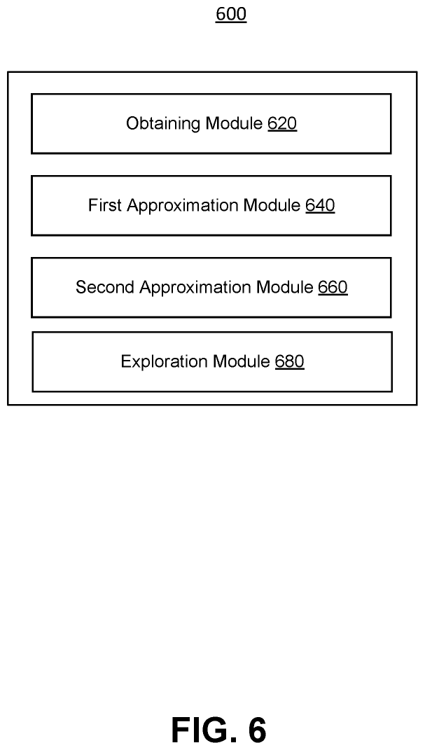

FIG. 6 illustrates a block diagram of a computer system for risk detection in accordance with some embodiments. The computer system 600 may be an example of an implementation of one or more modules in the computing system in FIG. 1, or one or more other components illustrated in FIGS. 1-5. The method 500 in FIG. 5 may be implemented by the computer system 600. The computer system 600 may comprise one or more processors and one or more non-transitory computer-readable storage media (e.g., one or more memories) coupled to the one or more processors and configured with instructions executable by the one or more processors to cause the system or device (e.g., the processor) to perform the above-described method, e.g., the method 500. The computer system 600 may comprise various units/modules corresponding to the instructions (e.g., software instructions).

In some embodiments, the computer system 600 may be referred to as an apparatus for risk detection. The apparatus may comprise a obtaining module 620 for obtaining a first subset of the plurality of risk-detection rules, the first subset being associated with a first coverage score and a first disruption score, wherein: the first coverage score indicates a number of unique historical transactions that have been correctly identified by the plurality of risk-detection rules in the first subset, and the first disruption score indicates a number of unique historical transactions that have been falsely identified by the plurality of risk-detection rules in the first subset; a first approximation module 640 for constructing, based on the first subset, a lower-bound data mapping that outputs an approximate coverage score for an input subset; and a second approximation module 660 for constructing, based on the first subset, an upper-bound data mapping comprising a set of parameters; and an exploration module 680 for generating a third subset of the plurality of risk-detection rules according to the first subset, the lower-bound data mapping, and the upper-bound data mapping.

The techniques described herein may be implemented by one or more special-purpose computing devices. The special-purpose computing devices may be desktop computer systems, server computer systems, portable computer systems, handheld devices, networking devices or any other device or combination of devices that incorporate hard-wired and/or program logic to implement the techniques. The special-purpose computing devices may be implemented as personal computers, laptops, cellular phones, camera phones, smart phones, personal digital assistants, media players, navigation devices, email devices, game consoles, tablet computers, wearable devices, or a combination thereof. Computing device(s) may be generally controlled and coordinated by operating system software. Conventional operating systems control and schedule computer processes for execution, perform memory management, provide file system, networking, I/O services, and provide a user interface functionality, such as a graphical user interface (“GUI”), among other things. The various systems, apparatuses, storage media, modules, and units described herein may be implemented in the special-purpose computing devices, or one or more computing chips of the one or more special-purpose computing devices. In some embodiments, the instructions described herein may be implemented in a virtual machine on the special-purpose computing device. When executed, the instructions may cause the special-purpose computing device to perform various methods described herein. The virtual machine may include a software, hardware, or a combination thereof.

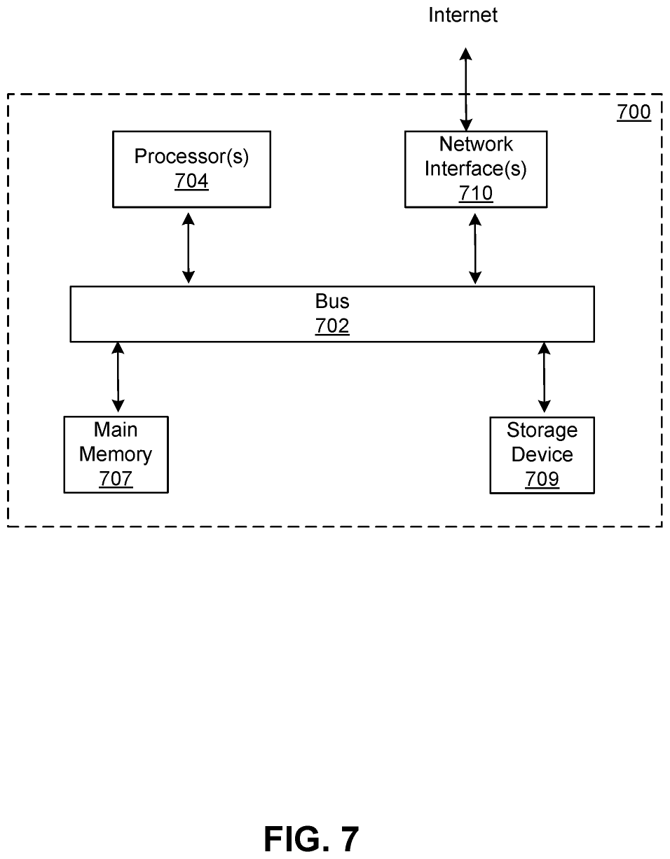

FIG. 7 illustrates an example computing device in which any of the embodiments described herein may be implemented. The computing device may be used to implement one or more components of the systems and the methods shown in FIGS. 1-5 The computing device 700 may comprise a bus 702 or other communication mechanism for communicating information and one or more hardware processors 704 coupled with bus 702 for processing information. Hardware processor(s) 704 may be, for example, one or more general purpose microprocessors.

The computing device 700 may also include a main memory 707, such as a random-access memory (RAM), cache and/or other dynamic storage devices, coupled to bus 702 for storing information and instructions to be executed by processor(s) 704. Main memory 707 also may be used for storing temporary variables or other intermediate information during execution of instructions to be executed by processor(s) 704. Such instructions, when stored in storage media accessible to processor(s) 704, may render computing device 700 into a special-purpose machine that is customized to perform the operations specified in the instructions. Main memory 707 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The computing device 700 may implement the techniques described herein using customized hard-wired logic, one or more ASICs or FPGAs, firmware and/or program logic which in combination with the computing device may cause or program computing device 700 to be a special-purpose machine. According to one embodiment, the techniques herein are performed by computing device 700 in response to processor(s) 704 executing one or more sequences of one or more instructions contained in main memory 707. Such instructions may be read into main memory 707 from another storage medium, such as storage device 709. Execution of the sequences of instructions contained in main memory 707 may cause processor(s) 704 to perform the process steps described herein. For example, the processes/methods disclosed herein may be implemented by computer program instructions stored in main memory 707. When these instructions are executed by processor(s) 704, they may perform the steps as shown in corresponding figures and described above. In alternative embodiments, hard-wired circuitry may be used in place of or in combination with software instructions.

The computing device 700 also includes a communication interface 710 coupled to bus 702. Communication interface 710 may provide a two-way data communication coupling to one or more network links that are connected to one or more networks. As another example, communication interface 710 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contributes to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method for risk detection, comprising:
obtaining a first subset of a plurality of risk-detection rules, the first subset being associated with a first coverage score and a first disruption score, wherein:
the first coverage score indicates a number of unique historical transactions that have been correctly identified by the plurality of risk-detection rules in the first subset, and
the first disruption score indicates a number of unique historical transactions that have been falsely identified by the plurality of risk-detection rules in the first subset;
constructing, based on the first subset, a lower-bound data mapping that outputs an approximate coverage score for an input subset, wherein:
when the input subset is the first subset, the approximate coverage score is the same as the first coverage score, and
when the input subset is a second subset different from the first subset, the approximate coverage score is not greater than a second coverage score associated with the second subset, the second coverage score indicating a number of unique historical transactions that have been correctly identified by risk-detection rules in the second subset; and
constructing, based on the first subset, an upper-bound data mapping comprising a set of parameters, wherein:
the upper-bound data mapping outputs an approximate disruption score for the input subset of the plurality of risk-detection rules,
when the input subset is the first subset, the output approximate disruption score is the same as the first disruption score, and
when the input subset is the second subset different from the first subset, the output approximate disruption score is not less than a second disruption score associated with the second subset, the second disruption score indicating a number of unique historical transactions that have been falsely identified as risky transactions by risk-detection rules in the second subset; and
according to the first subset, the lower-bound data mapping, and the upper-bound data mapping, generating a third subset of the plurality of risk-detection rules based at least on:
the approximate coverage scores output by the lower-bound data mapping corresponding to the plurality of risk-detection rules as inputs, and
the set of parameters associated with the upper-bound data mapping,
wherein the third subset is associated with a third coverage score indicating a number of unique historical transactions that have been correctly identified by the plurality of risk-detection rules in the third subset;
comparing the first coverage score with the third coverage score; and
in response to the first coverage score exceeding the third coverage score, selecting rules in the first subset for risk-detection on a new transaction.

2. The method of claim 1, further comprising:
in response to the first coverage score not exceeding the third coverage score, replacing the first subset with the third subset as an updated first subset, wherein the first coverage score is correspondingly replaced with the third coverage score of the third subset;
cyclically performing one or more iterations of a process based on the constructing step and the generating step until an exit condition is met, the process comprising:
updating, based on the updated first subset, the lower-bound data mapping;
generating, based on the updated first subset and the updated lower-bound data mapping, an updated third subset associated with an updated third coverage score; and
if the exit condition is not met, replacing the updated first subset with the updated third subset, and the updated first coverage score with the updated third coverage score.

3. The method of claim 2, wherein the exit condition comprises at least one of following: the updated first coverage score being greater than the updated third coverage score, and a number of the one or more iterations being greater than a preset number.

4. The method of claim 1, wherein the lower-bound data mapping comprises a submodular and monotonic function.

5. The method of claim 1, wherein the first subset is empty.

6. The method of claim 1, wherein the constructing a lower-bound data mapping comprises:
generating a sequence by reordering the plurality of risk-detection rules, wherein risk-detection rules in the first subset are placed first in the sequence;
based on the generated sequence, constructing a list of temporal subsets Sᵢ, 0≤i≤n, wherein:
n is a quantity of the plurality of risk-detection rules,
temporal subset S₀ is empty, and
for a given i where 1≤i≤n, temporal subset Sᵢ comprises an iₜₕ risk-detection rule in the sequence and all risk-detection rules in temporal subset Sᵢ₋₁;
determining the approximate coverage score for each risk-detection rule in the generated sequence; and
determining a coverage score for a given subset of the plurality of risk-detection rules as a sum of the approximate individual coverage score of each risk-detection rule in the given subset.

7. The method of claim 6, wherein the determining the approximate individual coverage score for each risk-detection rule in the sequence comprises:
for the iₜₕ risk-detection rule in the sequence, determining an approximate individual coverage score based on a difference between a coverage score of the temporal subset Sᵢ and a coverage score of the temporal subset Sᵢ₋₁, wherein the coverage score of the temporal subset Sᵢ and the coverage score of the temporal subset Sᵢ₋₁ are learned by querying the database of historical transactions.

8. The method of claim 1, wherein the constructing an upper-bound data mapping with a set of parameters comprises determining the set of parameters by:
for each of the plurality of risk-detection rules:
determining a first approximate coverage score based on the lower-bound data mapping;
determining a first disruption score increase associated with adding the each risk-detection rule to a first group of risk-detection rules based on a number of unique historical transactions that have been falsely identified by the each risk-detection rule; and
determining a first ratio for the each risk-detection rule, wherein the approximate coverage score is a numerator and the first disruption score increase is a denominator;
generating a sequence by sorting the plurality of risk-detection rules in a descending order according to the determined first ratios of the plurality of risk-detection rules;
selecting a maximum number of risk-detection rules with a first overall disruption score increases being not greater than the preset threshold, wherein the first overall disruption score is a summation of the first disruption score increases associated with the selected risk-detection rules; and
determining the set of parameters as an intersection of the first subset and the selected risk-detection rules.

9. The method of claim 8, wherein the first group is determined as the first subset if the each risk-detection rule is not in the first subset, or as the first subset excluding the each risk-detection rule if the each risk-detection rule is in the first subset.

10. The method of clam 1, wherein the generating a third subset of the plurality of risk-detection rules comprises:
sorting the plurality of risk-detection rules based on the first subset, the set of parameters, and the approximate coverage scores generated by the lower-bound data mapping for the plurality of risk-detection rules; and
from a beginning of the sorted plurality of risk-detection rules, selecting one or more consecutive risk-detection rules as the third subset.

11. The method of claim 10, wherein the sorting the plurality of risk-detection rules comprises:
for each of the plurality of risk-detection rules:
determining a second approximate coverage score based on the lower-bound data mapping;
determining a second group of risk-detection rules as the set of parameters if the each risk-detection rule is not in the first subset, or as the first subset excluding the each risk-detection rule if the each-detection rule is in the first subset;
determining a second disruption score increase associated with adding the each risk-detection rule to the second group of risk-detection rules; and
determining a second ratio for the each risk-detection rule, wherein the second approximate coverage score is a numerator and the second disruption score increase is a denominator;
generating a sequence by sorting the plurality of risk-detection rules in a descending order according to the second ratio of the each risk-detection rule; and
wherein the selecting one or more consecutive risk-detection rules as the third subset comprises:
selecting a maximum number of risk-detection rules with a second overall disruption score increases being not greater than the preset threshold, wherein the second overall disruption score is a sum of the second disruption score increases associated with the selected risk-detection rules.

12. A system for risk detection, comprising one or more processors and one or more non-transitory computer-readable memories coupled to the one or more processors and configured with instructions executable by the one or more processors to cause the system to perform operations comprising:
obtaining a first subset of a plurality of risk-detection rules, the first subset being associated with a first coverage score and a first disruption score, wherein:
the first coverage score indicates a number of unique historical transactions that have been correctly identified by the plurality of risk-detection rules in the first subset, and
the first disruption score indicates a number of unique historical transactions that have been falsely identified by the plurality of risk-detection rules in the first subset;
approximate coverage score for an input subset, wherein:
when the input subset is the first subset, the approximate coverage score is the same as the first coverage score, and
when the input subset is a second subset different from the first subset, the approximate coverage score is not greater than a second coverage score associated with the second subset, the second coverage score indicating a number of unique historical transactions that have been correctly identified by risk-detection rules in the second subset; and
constructing, based on the first subset, an upper-bound data mapping comprising a set of parameters, wherein:
the upper-bound data mapping outputs an approximate disruption score for the input subset of the plurality of risk-detection rules,
when the input subset is the first subset, the output approximate disruption score is the same as the first disruption score, and
when the input subset is the second subset different from the first subset, the output approximate disruption score is not less than a second disruption score associated with the second subset, the second disruption score indicating a number of unique historical transactions that have been falsely identified as risky transactions by risk-detection rules in the second subset; and
according to the first subset, the lower-bound data mapping, and the upper-bound data mapping, generating a third subset of the plurality of risk-detection rules based at least on:
the approximate coverage scores output by the lower-bound data mapping corresponding to the plurality of risk-detection rules as inputs, and
the set of parameters associated with the upper-bound data mapping,
wherein the third subset is associated with a third coverage score indicating a number of unique historical transactions that have been correctly identified by the plurality of risk-detection rules in the third subset;
comparing the first coverage score with the third coverage score; and
in response to the first coverage score exceeding the third coverage score, selecting rules in the first subset for risk-detection on a new transaction.

13. The system of claim 12, wherein the operations further comprise:
in response to the first coverage score not exceeding the third coverage score, replacing the first subset with the third subset as an updated first subset, wherein the first coverage score is correspondingly replaced with the third coverage score of the third subset;
cyclically performing one or more iterations of a process based on the constructing step and the generating step until an exit condition is met, the process comprising:
updating, based on the updated first subset, the lower-bound data mapping;
generating, based on the updated first subset and the updated lower-bound data mapping, an updated third subset associated with an updated third coverage score; and
if the exit condition is not met, replacing the updated first subset with the updated third subset, and the updated first coverage score with the updated third coverage score.

14. The system of claim 13, wherein the exit condition comprises at least one of following: the updated first coverage score being greater than the updated third coverage score, and a number of the one or more iterations being greater than a preset number.

15. The system of claim 12, wherein the lower-bound data mapping comprises a submodular and monotonic function.

16. The system of claim 12, wherein the first subset is empty.

17. A method for selecting a subset from a collection of candidates, comprising:
obtaining a first subset of a plurality of candidates, the first subset being associated with a first true-positive score and a first false-positive score, wherein:
the first true-positive score indicates a gain associated with candidates in the first subset, and
the first false-positive score indicates a cost associated with candidates in the first subset;
constructing, based on the first subset, a lower-bound data mapping that outputs an approximate true-positive score for an input subset, wherein:
when the input subset is the first subset, the approximate true-positive score is the same as the first true-positive score, and
when the input subset is a second subset different from the first subset, the approximate true-positive score is not greater than a second true-positive score associated with the second subset, the second true-positive score indicating a gain associated with candidates in the second subset; and
constructing, based on the first subset, an upper-bound data mapping comprising a set of parameters, wherein:
the upper-bound data mapping outputs an approximate false-positive score for the input subset of the plurality of candidates,
when the input subset is the first subset, the output approximate false-positive score is the same as the first false-positive score, and
when the input subset is the second subset different from the first subset, the output approximate false-positive score is not less than a second false-positive score associated with the second subset, the second false-positive score indicating a gain associated with candidates in the second subset; and
according to the first subset, the lower-bound data mapping, and the upper-bound data mapping, generating a third subset of the plurality of candidates based at least on:
the approximate true-positive scores output by the lower-bound data mapping corresponding to the plurality of candidates as inputs, and
the set of parameters associated with the upper-bound data mapping,
wherein the third subset is associated with a third true-positive score indicating a gain associated with the plurality of candidates in the third subset;
comparing the first true-positive score with the third true-positive score; and
in response to the first true-positive score exceeding the third true-positive score, selecting candidates in the first subset for on a new transaction.

18. The method of claim 17 further comprising:
in response to the first true-positive score not exceeding the third true-positive score, replacing the first subset with the third subset as an updated first subset, wherein the first true-positive score is correspondingly replaced with the third true-positive score of the third subset;
cyclically performing one or more iterations of a process based on the constructing step and the generating step until an exit condition is met, the process comprising:
updating, based on the updated first subset, the lower-bound data mapping;
generating, based on the updated first subset and the updated lower-bound data mapping, an updated third subset associated with an updated third true-positive score; and
if the exit condition is not met, replacing the updated first subset with the updated third subset, and the updated first true-positive score with the updated third true-positive score.

19. The method of claim 17, wherein the exit condition comprises at least one of following: the updated first true-positive score being greater than the updated third true-positive score, and a number of the one or more iterations being greater than a preset number.

20. The method of claim 17, wherein the first subset is empty.
